(19) United States
(12) Patent Application Publication
(10) Pub. No.: US 2023/0006335 A1
(43) Pub. Date: Jan. 5, 2023

(54) ANTENNA ASSEMBLY AND ELECTRONIC DEVICE

(71) Applicant: GUANGDONG OPPO MOBILE TELECOMMUNICATIONS CORP., LTD., Dongguan (CN)

(72) Inventor: Fan YANG, Dongguan (CN)

(73) Assignee: GUANGDONG OPPO MOBILE TELECOMMUNICATIONS CORP., LTD., Dongguan (CN)

(21) Appl. No.: 17/940,973

(22) Filed: Sep. 8, 2022

Related U.S. Application Data
(63) Continuation of application No. PCT/CN2021/073567, filed on Jan. 25, 2021.

(30) Foreign Application Priority Data
Mar. 12, 2020 (CN) 202010169497.5
Mar. 12, 2022 (CN) 202020306585.0

(51) Int. Cl. H01Q 1/24; H01Q 1/38; H01Q 9/30

(52) U.S. Cl. CPC H01Q 1/243; H01Q 1/38; H01Q 9/30

(57) ABSTRACT

An antenna assembly includes a conductive frame, a filter module, and a feeding module. The conductive frame defined at least one gap. The gap divides the conductive frame into a first conductive branch with a first feeding point and a second conductive branch with a second feeding point. The first feed circuit is to feed an adjustable first current signal to the first conductive branch via the first filter circuit and the first feeding point, so that a first radiator on the first conductive branch is adjustable to radiate a first signal. The second feed circuit is to feed a second current signal to the second conductive branch via the second filter circuit and the second feeding point, and a second radiator on the second conductive branch radiates a second signal. An electronic device is also provided.

### CROSS REFERENCE TO RELATED APPLICATIONS

This application is a continuation of International Patent Application No. PCT/CN2021/073567, filed on Jan. 25, 2021, which claims priority to Chinese Patent Applications No. 202010169497.5 and No. 202020306585.0, both filed on Mar. 12, 2020. The entire disclosure of the aforementioned patent applications are incorporated herein by reference.

### TECHNICAL FIELD

This disclosure relates to the field of antenna technology, and in particularly to an antenna assembly and an electronic device having the antenna assembly.

### BACKGROUND

With the development of the wireless communication technology, more and more users are concerned about the portability and appearance of an electronic device. An antenna of the electronic device with a metal frame is mainly based on the metal frame. A section height of the metal frame is one of the main factors affecting the radiation efficiency of the antenna. The section height of the metal frame of the electronic device can be regarded as a width of the metal frame in a thickness direction of the electronic device.

### SUMMARY

Various implementations disclosed herein include an antenna assembly and an electronic device having the antenna assembly.

The present disclosure provides an antenna assembly and an electronic device which improves the space utilization of the slot and conductive frame.

An antenna assembly is provided in the present disclosure. The antenna assembly includes a conductive frame, a filter module, and a feeding module. The conductive frame has at least one gap. The gap divides the conductive frame to have at least a first conductive branch and a second conductive branch independent with each other. A first feeding point is provided on the first conductive branch. A second feeding point is provided on the second conductive branch. The filter module includes a first filter circuit and a second filter circuit. A feeding module includes a first feeding circuit and a second feeding circuit. The first feed circuit is configured to feed an adjustable first current signal to the first conductive branch via the first filter circuit and the first feeding point, so that a first radiator on the first conductive branch is adjustable to radiate a first signal. The second feed circuit is configured to feed a second current signal to the second conductive branch via the second filter circuit and the second feeding point, a second radiator on the second conductive branch radiates a second signal.

In at least one embodiment, an antenna assembly is provided in the present disclosure. The antenna assembly includes a conductive frame, a filter module, and a feeding module. The conductive frame has at least one gap. The gap divides the conductive frame to have at least a first conductive branch and a second conductive branch independent with each other. A first feeding point is provided on the first conductive branch. A second feeding point is provided on the second conductive branch. The filter module includes a first filter circuit and a second filter circuit. The feeding module includes a first feeding circuit and a second feeding circuit. The first feed circuit is configured to feed an adjustable first current signal to the first conductive branch via the first filter circuit and the first feeding point, so that a first radiator on the first conductive branch is adjustable to radiate a first signal. The second feed circuit is configured to feed a second current signal to the second conductive branch via the second filter circuit and the second feeding point, so that a second radiator on the second conductive branch radiates a second signal.

In at least one embodiment, the first filter circuit is a high-pass filter circuit, and the second filter circuit is a low-pass filter circuit.

In at least one embodiment, the first filter circuit includes a first capacitor and a first inductor. A first end of the first capacitor is connected with a first end of the first inductor and the first feeding point. The other end of the first capacitor is connected with the first feed circuit. A second end of the first inductor is grounded.

In at least one embodiment, the second filter circuit includes a second capacitor and a second inductor. A first end of the second inductor is connected with the first end of the second capacitor and the second feeding point. The other end of the second inductor is connected with the second feed circuit. The second end of the second inductor is grounded.

In at least one embodiment, the antenna assembly includes a switching module, the switching module is connected with the first feeding point, the first filter circuit. The switching module is configured to adjust the first current signal fed to the first feeding point so that the first radiator radiates the first radio-frequency signals with a working frequency band.

In at least one embodiment, the switching module includes a plurality of third capacitors and a switch unit. The switch unit includes a control end and a plurality of selection ends. The control end is connected with the first feeding point and the first filter circuit. Each of the selection ends is grounded via the third capacitors respectively.

In at least one embodiment, the switching module includes a plurality of third inductors and a switch unit. The switch unit includes a control end and a plurality of selection ends. The control end is connected with the first feeding point and the first filter circuit. Each of the selection ends is grounded via the third inductors respectively.

In at least one embodiment, the first conductive branch is further provided with a first ground point. The first feeding point is adjacent to the gap. The first ground point is away from the gap. And a portion of the first conductive branch between the first feeding point and the first ground point forms the first radiator. The second conductive branch is further provided with a second ground point. The second feeding point is adjacent to the gap. The second ground point is far away from the gap. A part of the first conductive branch between the second feeding point and the second ground point forms the second radiator.

In at least one embodiment, the antenna assembly includes a first matching circuit and a second matching circuit. The first matching circuit is connected between the first conductive branch and the first feed circuit. And the first matching circuit is configured to adjust the first signals. The second matching circuit is connected between the second conductive branch and the second feed circuit and is configured to adjust the second signal.

In at least one embodiment, each of the first matching circuit and the second matching circuit can include one or more capacitors and/or one or more inductors.

In at least one embodiment, the first filter circuit is coupled to the first conductive branch through a first feeding part. The coupling point of the first feeding part and the first conductive branch can be used as a first feeding point. The second filter circuit is coupled to the second conductive branch through a second feeding part. The coupling point of the second feeding part and the second conductive branch can be used as a second feeding point.

In at least one embodiment, the number of the gap is two. The two gaps divide the conductive frame into a first conductive branch, a second conductive branch and a third conductive branch. A feeding point and a ground point are provided to the third conductive branch. The third conductive branch is integrated with a third radiator for radiating a third radio-frequency signal.

In at least one embodiment, the working frequency band of the first radio-frequency signal at least includes two working frequency bands of fifth generation (SG) new radio (NR) signal and two working frequency bands of long term evolution (LTE) radio signal. The second radio-frequency signal includes a satellite positioning signal.

In at least one embodiment, the working frequency band of the SG NR signal at least includes a N78 frequency band and a N79 frequency band. The satellite positioning signal includes a GPS L1 frequency band or a radio-frequency signal of the GPS L5 frequency band.

An electronic device is provided in the present disclosure. The electronic device includes a substrate, a conductive frame, a filter module, a feeding module. The conductive frame has at least one gap. The gap divides the conductive frame to have at least a first conductive branch and a second conductive branch independent with each other. A first feeding point is provided on the first conductive branch. A second feeding point is provided on the second conductive branch. The filter module includes a first filter circuit and a second filter circuit. The feeding module includes a first feeding circuit and a second feeding circuit. The first feed circuit is configured to feed an adjustable first current signal to the first conductive branch via the first filter circuit and the first feeding point, so that a first radiator on the first conductive branch is adjustable to radiate a first signal. The second feed circuit is configured to feed a second current signal to the second conductive branch via the second filter circuit and the second feeding point, so that a second radiator on the second conductive branch radiates a second signal.

In at least one embodiment, the first filter circuit is a high-pass filter circuit, and the second filter circuit is a low-pass filter circuit.

In at least one embodiment, the first filter circuit includes a first capacitor and a first inductor. A first end of the first capacitor is connected with a first end of the first inductor and the first feeding point. And the other end of the first capacitor is connected with the first feed circuit. A second end of the first inductor is grounded. The second filter circuit includes a second capacitor and a second inductor. A first end of the second inductor is connected with the first end of the second capacitor and the second feeding point, and the other end of the second inductor is connected with the second feed circuit. The second end of the second inductor is grounded.

In at least one embodiment, the antenna assembly includes a switching module. The switching module is connected with the first feeding point and the first filter circuit and is used to adjust the first current signal fed to the first feeding point so that the first radiator can radiate the first radio-frequency signal with a working frequency band.

In at least one embodiment, the conductive frame includes a first frame and a third frame opposite to each other, a second frame and a fourth frame opposite to each other. The second frame respectively connects with the first frame and the third frame. The first conductive branch and the second conductive branch are integrated on the first frame or the third frame of the electronic device.

An antenna assembly is provided in the present disclosure. The antenna assembly includes a gap, a first frame, a conductive branch, a first conductive branch, and a second conductive branch. The gap dividing the conductive frame into the first conductive branch and the second conductive branch. The first conductive branch is configured to be fed a first adjustable signal for radiation of a first radiation signal with different frequency bands, and the second conductive branch is configured to be fed a second current signal for radiation of a second frequency signal with a fixed frequency band.

An electronic device is provided in the present disclosure. The electronic device includes a substrate, a conductive frame, a filter module, and a feeding module. The conductive frame has at least one gap. The gap divides the conductive frame to have at least a first conductive branch and a second conductive branch independent with each other. A first feeding point is provided on the first conductive branch. A second feeding point is provided on the second conductive branch. The filter module includes a first filter circuit and a second filter circuit. The feeding module includes a first feeding circuit and a second feeding circuit. The first conductive branch is configured to be fed a first adjustable signal for radiation of a first radiation signal with different frequency bands, and the second conductive branch is configured to be fed a second current signal for radiation of a second frequency signal with a fixed frequency band.

An antenna assembly is provided, including: a gap, a first frame, a conductive branch, a first conductive branch, and a second conductive branch. The gap dividing the conductive frame into the first conductive branch and the second conductive branch. The first conductive branch is configured to be fed into an adjustable first current signal to radiate a first signal. The second conductive branch is configured to be fed into a second current signal to radiate a second signal.

The details of one or more embodiments of the present disclosure are presented in the following drawings and descriptions. Other features of the present disclosure, the object and advantages will be apparent from the specification, drawings, and claims.

### BRIEF DESCRIPTION OF THE DRAWINGS

in order to describe technical solutions of implementations of the present disclosure more clearly, the following will give a brief introduction to the accompanying drawings used for describing the implementations. Apparently, the accompanying drawings hereinafter described are merely some implementations of the present disclosure. Based on these drawings, those of ordinary skill in the art can also obtain other drawings without creative effort.

FIG. 1 is an isometric view of an electronic device in one embodiment.

FIG. 2 is a first schematic structural diagram of an antenna assembly of an electronic device in an embodiment of the present disclosure.

FIG. 3 is a second schematic structural diagram of an antenna assembly of an electronic device in an embodiment of the present disclosure.

FIG. 4 is a third schematic structural diagram of an antenna assembly of an electronic device in an embodiment of the present disclosure.

FIG. 5 is a fourth schematic structural diagram of an antenna assembly of an electronic device in an embodiment of the present disclosure.

FIG. 6 is a simulation diagram of the performance of an antenna assembly of an electronic device in an embodiment of the present disclosure;

FIG. 7 is a fifth schematic structural diagram of an antenna assembly of an electronic device in an embodiment of the present disclosure.

### DETAILED DESCRIPTION

In order to make the purpose of the present disclosure, technical solutions and advantages are more clearly understood, the following combine the accompanying drawings and examples, for further detailed explanation of this disclosure. It should be understood that the specific embodiments described herein is only for explaining the disclosure, and not for defining or limiting the disclosure.

It can be understood that the term “first”, “second” used in the present disclosure can be used herein to describe various elements, but these elements are not limited by these terms. These terms are only used to distinguish the first element from another element, and cannot be understood as indicating or implying the relative importance or implicitly indicating the number of technical features indicated. In the description of the present disclosure, the meaning of “a plurality of” is at least two, such as two, three, or more than three, unless there is a specific definition specifically.

It should be noted that, when one element is “connected” with the other element, it may be directly connected to another element or may be present at the same time as the centering element.

In an embodiment, an antenna assembly of the present disclosure can be applied to an electronic device. The electronic device may include a mobile phone, a tablet computer, a notebook computer, a palmtop computer, a Mobile Internet Device (MID), a wearable device (such as smart watches, smart bracelets, pedometers, etc.) or other communication modules that can be equipped with array antenna components.

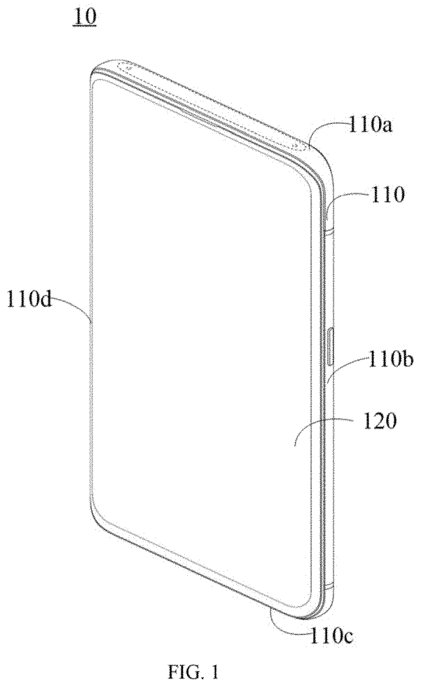

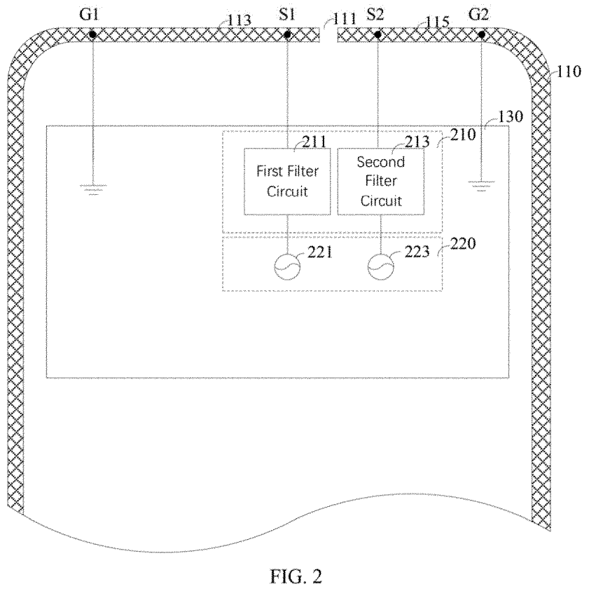

FIG. 1 illustrates an electronic device 10. The electronic device 10 may include a conductive frame 110, a rear cover, a display screen assembly 120, a substrate 130 (illustrated in FIG. 2) and a radio-frequency circuit. The display screen assembly 120 is fixed with the conductive frame 110 and a housing assembly formed by the rear cover. The display screen assembly 120 and the housing assembly corporately form an external structure of the electronic device 10. The display screen assembly 120 can be used for displaying pictures or fonts to users, and can be functioned as an operation interface for the users.

The rear cover functions as an outer contour of the electronic device 10. The rear cover can be integrally formed as a single piece. A structure, such as a rear camera hole, a fingerprint identification module, an antenna assembly mounting hole may be formed in the forming process of the rear cover. The rear cover can be a non-metal rear cover, such as a plastic rear cover, a ceramic rear cover or a 3D glass rear cover.

In at least one embodiment, the conductive frame 110 may be a frame structure defining a through hole. The conductive frame 110 may include a metal frame such as an aluminum alloy frame or a magnesium alloy.

In at least one embodiment, the conductive frame 110 is a rounded rectangular frame. The conductive frame 110 may include a first frame 10a and a third frame 110c opposite to each other, and a second frame 110b and a fourth frame 110d opposite to each other. The second frame 110b respectively connects with the first frame 110a and the third frame 110c. The first frame 110a can be a top frame of the electronic device 10, the third frame 110c can be a bottom frame of the electronic device 10, and the second frame 110b and the fourth frame 110d can be a side frame of the electronic device 10 respectively.

In one embodiment, a part of the antenna assembly may be formed by a part of the conductive frame 110. Alternatively, the entire antenna assembly may be formed by a part of the conductive frame 110. In some embodiments, a radiator of the antenna assembly can be partially or entirely integrated on at least one of the top frames, the bottom frame and the side frame of the electronic device 10.

Referring now to FIG. 2, the substrate 130 may be accommodated in a receiving space defined by the conductive frame 110 and the rear cover. The substrate 130 may be a printed circuit board (PCB) or a flexible printed circuit board (FPC). A part of a radio-frequency circuit for processing an antenna signal can be integrated on the substrate 130. A controller used to control the electronic device 10 can also be integrated on the substrate 130. The radio-frequency circuit includes, but not limited to, an antenna assembly, at least one amplifier, a transceiver, a coupler, a low noise amplifier (LNA), and a duplexer. The radio-frequency circuit can also communicate with a network and other devices via wireless communication.

The aforementioned wireless communication may be based on any communication standards or protocols, including, but not limited to, Global System of Mobile communication (GSM), General Packet Radio Service (GPRS), code division multiple access (CDMA), Wideband Code Division Multiple Access (WCDMA), Long Term Evolution (LTE), fifth generation (5G) New Radio (NR), email, or Short Messaging Service (SMS).

The antenna assembly illustrated in FIG. 2 includes a conductive frame 110, a filter module 210 and a feeding module 220.

The conductive frame 110 has at least one gap 111. The conductive frame 110 is divided into an independent first conductive branch 113 and an independent second conductive branch 115 at two opposite sides of the gap 111.

In at least one embodiment, the gap 111, functioning as a portion of the antenna assembly, can be a slit. The conductive frame 110 can be divided into at least two independent conductive branches. In some embodiments, the conductive frame 110 can be divided into the independent first conductive branch 113 and the independent second conductive branch 115. In other embodiments, the conductive frame 10 have N (N>1) gaps 111, the conductive frame 110 can be divided into independent N÷1 conductive branches.

In one embodiment, the gap 111 can be filled with air, plastic and/or other dielectric material.

In one embodiment, the gap 111 may have a straight shape, or may have one or more curved shapes.

The gap 111 can be defined at any position of the conductive frame 110. In embodiments of this disclosure, shape, size, and the number of the gap 111 are not further defined or limited.

Each conductive branch can be provided with a feeding point. The first conductive branch 113 can be provided with a first feeding point S1. The second conductive branch 115 can be provided with a second feeding point S2.

The filter module 210 includes a first filter circuit 211 and a second filter circuit 213. The first filter circuit 211 is configured to filter out radio-frequency (RF) signals other than a first radio-frequency signal corresponding to a first radio-frequency, so that the first radio-frequency signal flows through the first filter circuit 211. A second filter circuit 213 is configured for filtering out RF signals other than a second radio-frequency signal corresponding to a second radio-frequency, so that the second radio-frequency signal flows through the second filter circuit 213.

The feeding module 220 includes a first feeding circuit 221 and a second feeding circuit 223. The first feed circuit 221 is configured to feed an adjustable first current signal to the first conductive branch 113 via the first filter circuit 211 and the first feeding point S1, so that a first radiator on the first conductive branch 113 can be adjusted to radiate the first radio-frequency signal in difference frequency ranges. The first current signal can be adjusted by changing the current numerical value of it.

The second feed circuit 223 is configured to feed an adjustable second current signal to the second conductive branch 115 via the second filter circuit 213 and the second feeding point S2, so that a second radiator on the second conductive branch 115 can be adjusted to radiate the second radio-frequency signal. While the frequency band of the first radio-frequency signal varies with the adjustable first current signal, the frequency band of the second radio-frequency signal remains unchanged. A working frequency bands of the first radio-frequency signal is different from the working frequency band of the second radio-frequency signal.

In at least one embodiment, the first radio-frequency signal may include radio-frequency signals of different frequency bands. For example, the first radio-frequency signals may include an LTE signal and a 5G NR signal. The working frequency bands of the first radio-frequency signals at least includes two working frequency bands of the 5G NR signal and two working frequency bands of the LTE signal.

LTE signals can be divided into low frequency radio-frequency signal (Low band, LB), intermediate frequency radio-frequency signals (Middle band, MB), and high frequency radio-frequency signals (High band, HB). In at least one embodiment of this disclosure, with the feeding from the first feeding circuit 221, the first radiator of the first conductive branch 113 can radiate the intermediate frequency radio-frequency signals and the high frequency radio-frequency signals corresponding to that of the LTE signals. The frequency range of the intermediate frequency radio-frequency signal is from 17 MHz to 2170 MHz, and the frequency range of the high frequency radio-frequency signal is from 2300 MHz to 2690 MHz.

The working frequency bands of the 5G NR signal at least includes a N78 frequency band and a N79 frequency band, and the frequency range of the N78 frequency band is from 3.3 GHz to 3.6 GHz, and the frequency range of the N79 frequency band can be from 4.8 GHz to 5 GHz.

Therefore, the first radiator can be used for radiating and receiving the radio-frequency signals corresponding to N78 and N79 in the SG NR working frequency band, and meanwhile it can also be used for the radiating and receiving intermediate frequency and high frequency radio-frequency signals corresponding to the LTE signal.

In at least one embodiment, the second radio-frequency signal includes a satellite positioning signal. The satellite positioning signal includes at least one of the following signals: global positioning system (GPS) signal with frequency range from 1.2 GHz to 1.6 GHz, BeiDou satellite navigation system (BDS) signals, and the Global Navigation Satellite System (GLONASS) signals. For example, the second radiator can be used for radiating GPS L1 frequency band signals or GPS L5 frequency band signals.

The antenna assembly according to the embodiments can radiate the first radio-frequency signal and also maintain the resonant frequency of the GPS L1 or GPS L5 unchanged. By which, the cellular networking and GPS positioning can work simultaneously without affecting each other.

In one embodiment, the antenna assembly includes a conductive frame 110. The conductive frame 110 has at least one gap 111. The gap 111 divides the conductive frame 110 to have at least a first independent conductive branch 113 and a second independent conductive branch 115. A first feeding point S1 is provided on the first conductive branch 113. The first feed circuit 221 is configured to feed an adjustable first current signal to the first conductive branch 113 via the first filter circuit 211 and the first feeding point S1, so that a first radiator on the first conductive branch 113 is adjustable to radiate a first signal.

The second feed circuit 223 is configured to feed a second current signal to the second conductive branch 115 via the second filter circuit 213 and the second feeding point S2, so that a second radiator on the second conductive branch 115 radiates a second signal, and while the frequency band of the first signal varies with the adjustable first current signal, the frequency band of the second signal remains unchanged. By defining the gap 111 between the first conductive branch 113 and the second conductive branch 115, when the antenna assembly works, the first conductive branch 113 radiates the first radio-frequency signals, simultaneously the second conductive branch 115 radiates the second radio-frequency signal, which improves the space utilization of the gap 111 and the conductive frame 110 of the electronic device 10. And a thickness of the electronic device is reduced without an extra antenna radiator for radiation.

In at least one embodiment, the first radiator and the second radiator can be integrated with the first frame or on the third frame of the electronic device 10 to improve the utilization of the top frame or the bottom frame, which avoids integrating the first radiator and the second radiator with side frames. In that way, a section height of the side frame can be reduced. The section height of the side frame can be reduced to be less than 1 mm. The section height of the side frame can be the width of the conductive frame 110 in the thickness direction of the electronic device 10, which is one of the factors affecting the radiation efficiency of an antenna. With the trend of curved screens with increasing side curvature, even the antenna clearance in the side frame for integrated antenna is greatly reduced, the antenna assembly can be alternatively integrated on the top frame or the bottom frame, thereby without affecting the flexibility and performance of the antenna assembly.

In at least one embodiment, the first conductive branch 113 is further provided with a first ground point G1. The first feeding point S1 is adjacent to the gap 111. The first ground point G1 can be away from the gap 111. A part of the first conductive branch 113 between the first feeding point S1 and the first ground point G1 forms the first radiator.

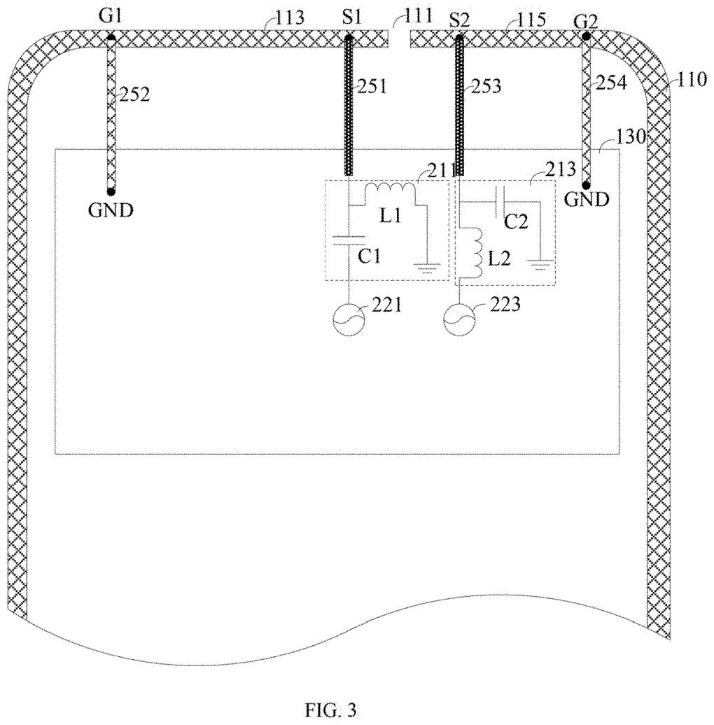

FIG. 2 and FIG. 3 illustrate, the first feeding circuit 221 and the first filter circuit 211 can be arranged on the substrate 130. The first filter circuit 211 can be coupled to the first conductive branch 113 via the first feeding part 251. The first feeding point S1 can be a coupling point of the first feeding part 251 and the first conductive branch 113. The first feeding part 251 can be a conductive elastic sheet or a coupling screw. The first feeding point S1 can be connected with the first filter circuit 211 through first feeding part 251. The first current signal output by the first feeding circuit 221 can pass through the first filter circuit 211 to feed the adjustable first current signal to the first conductive branch 113 via the first feeding point S1 by the first feeding part 251, so that a first radiator can radiate first radio-frequency signals having a plurality of different working bands.

In at least one embodiment, the first ground point G1 can be connected with a ground layer of the substrate 130 through the first connecting part 252 to connect with a ground. The first connecting part 252 can be an elastic sheet, a screw or a flexible circuit board. The first connecting part 252 can be a connecting arm made of the same material as the first conductive branch 113. For example, the first connecting part 252 and the first conductive branch 113 can be integrally formed to simplify the structure of the antenna assembly.

In at least one embodiment, the second conductive branch 115 is further provided with a second ground point G2. The second feeding point S2 is adjacent to the gap 111. The second ground point G2 is away from the gap 111. A part of the second conductive branch 115 between the second feeding point S2 and the second ground point G2 function as the second radiator.

The second feeding circuit 223 and the second filter circuit 213 can be arranged on the substrate 130. The second filter circuit 213 can be coupled to the second conductive branch 115 through a second feeding part 253. The second feeding part 253 and the second conductive branch 115 share a coupling point which can be functioned as the second feeding point S2. The second feeding part 253 can be a conductive elastic sheet or a screw, and the second feeding point S2 can be connected with the second filter circuit 213 through the conductive elastic sheet or the screw. The second current signal output by the second feeding circuit 223 can pass through the second filter circuit 213 to the second conductive branch 115 via the second feeding point S2 by the elastic sheet or the screw, to excite a quarter of the current or other modes on the second radiator to radiate the second signal.

In at least one embodiment, the second ground point G2 can be connected with a ground layer of the substrate 130 via the second connecting part 254 to connect with a ground. The second connecting part 254 can be an elastic sheet, a screw or a flexible circuit board, the second connecting part 254 can be a connecting arm made of the same material as the second conductive branch 115. For example, the second connecting part 254 and the second conductive branch 115 can be integrally formed to simplify the structure of the antenna assembly.

The working frequency band of the second radio-frequency signal of the second radiator can be adjusted by adjusting the length of the second radiator. When the second radiator is used to radiate GPS L1 frequency band signals, the length of the second radiator can be defined as the first length. When the second radiator is used to radiate the second the GPS L5 frequency band signals, the length of the second radiator can be defined as the second length. The second length is greater than the first length. In order to make the second radiator radiate the GPS L5 frequency band signal and GPS L1 frequency band signal, with increasing the length of the second radiator, parameters of the second filter circuit 213 and the second feeding circuit 223 may need to be adjusted correspondingly.

It should be clarified that the longer the radiator, the lower frequency band can be covered. The high frequency band has less demanding on the size of the radiator. The length of the first radiator and the length of the second radiator can be adjusted in accordance with the working frequency band of the first radio-frequency signal and the second radio-frequency signal.

It can be understood that the first radiator can be used to receive the first radio-frequency signals, the second radiator can be used to receive the second radio-frequency signals. Therefore, via the first radiator and the second radiator, the first signals and the second signals can be input (received) and output (radiated) correspondingly.

FIG. 3 illustrates that, in some embodiments, the first filter circuit 211 is a high-pass filter circuit. The high-pass filter circuit can be regarded as a passing-through state when the first radio-frequency signal passes through the first filter circuit 211, while the high-pass filter circuit blocks frequency signals having lower frequency than the first radio-frequency signals by the first filter circuit 211.

In some embodiments, the first filter circuit 211 includes a first capacitor C1 and a first inductor L1. A first end of the first capacitor C1 is connected with a first end of the first inductor L1 and the first feeding point S1. The other end of the first capacitor C1 is connected with the first feeding circuit 221. A second end of the first inductor L1 is grounded.

In one embodiment, the high-pass filter circuit may also include other devices, but not limited to the embodiments illustrated in the present disclosure.

In at least one embodiment, the second filter circuit 213 can be a low-pass filter circuit. The low-pass filter circuit can be in a pass-through state when the second radio-frequency signal passes through the second filter circuit 213, while the low-pass filter blocks frequency signals with higher frequency than the second radio-frequency signal by the second filter circuit 213.

The second filter circuit 213 includes a second capacitor C2 and a second inductor L2. A first end of the second inductor L2 is connected with a first end of the second capacitor C2 and the second feed S2. And the other end of the second inductor L2 is connected with the second feed circuit 223. A second end of the second inductor L2 is grounded.

In one embodiment, the low-pass filter circuit may also be composed of other components, not limited to the embodiment illustrated in the present application.

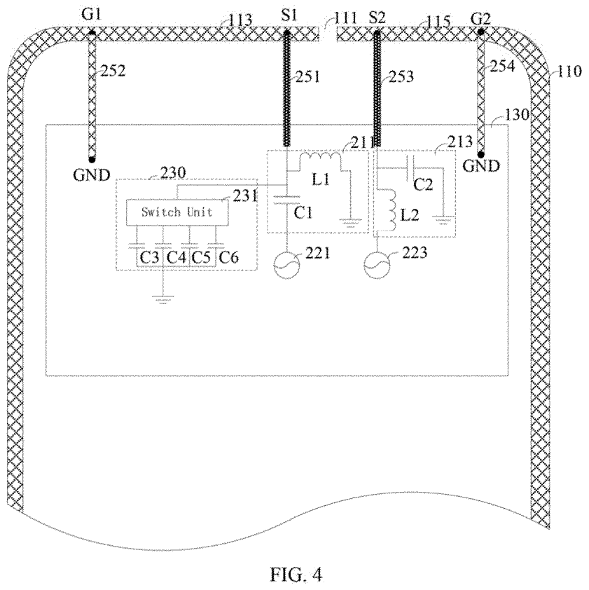

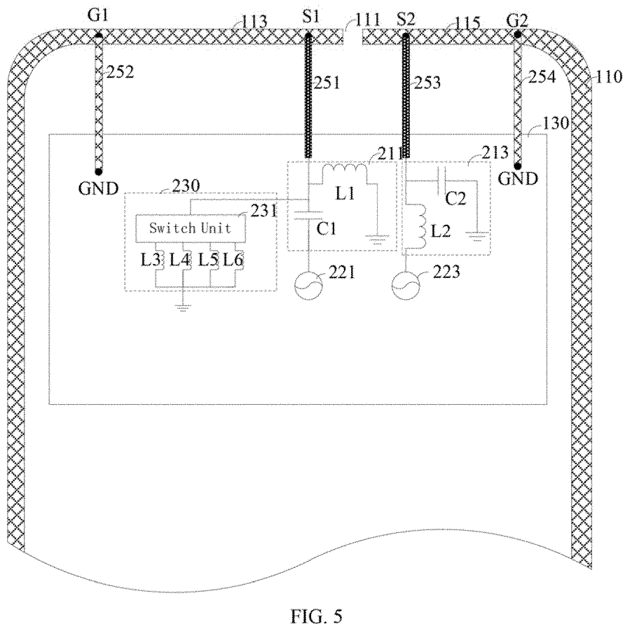

FIGS. 4 and 5 illustrate that, in some embodiments, the antenna assembly further includes a switching module 230. The switching module 230 is connected to the first feeding point S1 and the first filter circuit 211. The switching model 230 is used to adjust the first current signal fed to the first feeding point S1 to feed the first current signal an adjustable current signal, so that the first conductive branch 113 can radiate the first radio-frequency signals with any one of the working frequency bands.

FIG. 4 illustrates, in some embodiments, the switching module 230 includes a switch unit 231 and a plurality of third capacitors (C3, C4, C5, C6). The switch unit 231 includes a control end and a plurality of selection ends. The control end is connected with the first feeding point S1 and the first filter circuit 211. The selecting ends are grounded via the third capacitors respectively.

FIG. 5 illustrates, in some embodiments, the switching module 230 may include a switching unit 231 and a plurality of third inductors (L3, L4, L5, L6). The switch unit 231 includes a control end and a plurality of selection ends. The control end is respectively connected with the first feeding point S1 and the first filter circuit 211. The selecting ends are grounded through the third inductors respectively.

The number of the selecting end of the switch unit 231 can be set according to the number of the working frequency bands of the first radiator. The switch unit 231 can be a single-pole multi-throw switch. The movable end of the single-pole multi-throw switch can be used as the control end of the switch unit 231. The single-pole multi-throw switch of the non-movable end can be used as the selection end of the switch unit 231. Each of the non-moving ends of the single-pole multi-throw switch is connected with a capacitor respectively, and each of the capacitance of the capacitors is different.

It should be clarified that the switch unit 231 may also include a plurality of single-pole single-throw switches, a plurality of single-pole double-throw switches, a plurality of electronic switch tubes. The electronic switch tube can be a MOS tube or a transistor. In at least one embodiment of the disclosure, the specific components of the switch unit 231 is not further defined, which satisfy the switching selection condition of the plurality of third capacitors or a plurality of third inductors.

When the first radiator of the antenna assembly is used to radiate the first radio-frequency signals with different working frequency bands, the control switch unit 231 is used to select different tuning paths to adjust the working resonance frequency by adjusting the value of the third capacitor or the third inductor in the tuning paths, so as to fed an adjustable first current signal to the first conductive branch to adjust different working frequency bands.

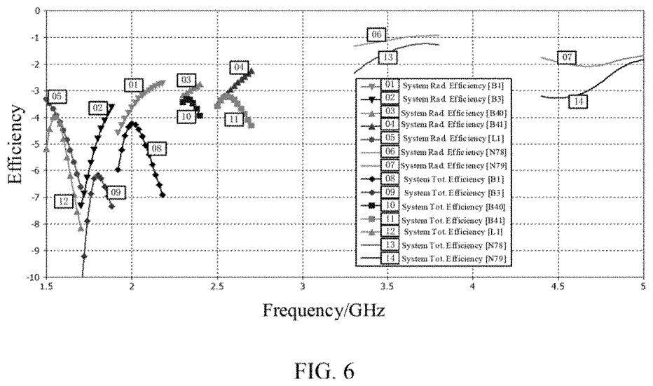

FIG. 6 illustrates, via the switching module 230 between the first feeding circuit 221 and the first filter circuit 211, a plurality of working frequency bands (e.g. MHB, N78; N79 working frequency band) of the first signals can be adjustable, and the resonant frequency of the second signals (e.g., GPS L1) can be maintained unchanged. Meanwhile, the radiation efficiency and the system efficiency of each working frequency band (e.g., working frequency band B1, B3, B40, B41, N78, N79) meet the communication requirements to achieve a cellular network and the GPS positioning work simultaneously without affecting each other.

It should be clarified that the frequency in the range of about 7%-13% of the resonance frequency can be regarded as the working bandwidth of the antenna. For example, the resonant frequency of the antenna is 1800 MHz, the working bandwidth is about 10% of the resonant frequency, and the working frequency band of the antenna is 1620 MHz-1980 MHz

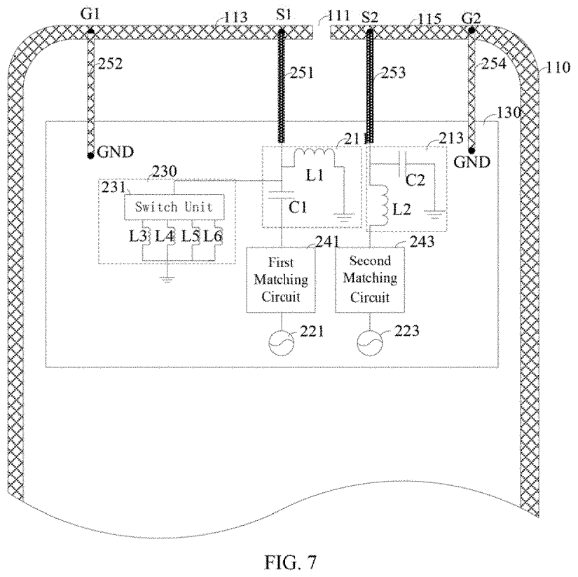

FIG. 7 illustrates, in some embodiments, a first matching circuit 241 for adjusting the first radio-frequency signals is provided between the first conductive branch 113 and the first feeding circuit 221. The first matching circuit 241 can be used to adjust an input impedance of the first radiator to improve the transmission performance of the first radiator.

A second matching circuit 243 for adjusting the second radio-frequency signals 243 is provided between the second conductive branch 115 and the second feeding circuit 223. The second matching circuit 243 can be used to adjust an input impedance of the second radiator to improve the transmission performance of the second radiator.

The first matching circuit 241 and the second matching circuit 243 may include a combination of one or more capacitors and/or one or more inductors. In at least one embodiment of this disclosure, the first matching circuit 241 and the second matching circuit 243 of the specific form is not further defined.

It should be clarified that the first feeding point S1 can be adjacent to the gap 111. The second feeding point S2 can be adjacent to the gap 111. It can be understood that the position of the first feeding point S1 is associated with the first matching circuit 241. That is, the position of the first feeding point S1 can be set in accordance with the first matching circuit 241. Correspondingly, the position of the second feeding point S2 is associated with the second matching circuit 243. That is, the position of the second feeding point S2 can be set according to the second matching circuit 243.

In at least one embodiment, the gap 111 is defined in the conductive frame 110 to divide the conductive frame 110 into a first independent conductive branch 113 and a second independent conductive branch 115. A first current signal is fed into the first conductive branch 113 adjacent to the gap 111 to excite the first conductive branch 113 to resonant in the LTE of the MHB frequency bands or in the N78 of the 5G NR frequency band, or in the N79 frequency band. A second current signal can be fed into the second conductive branch 115 adjacent to the gap 111 to excite the second conductive branch 115 to resonate in the GPS L1 or in GPS L5 frequency band. Thereby the first conductive branch 113 and the second conductive branch 115 can be used to radiate the GPS signals, MHB signals, N78 signals, and N79 signals by using a same gap 111, which can improve space utilization.

In at least one embodiment, a plurality of gaps 111 are defined in the conductive frame 110. In one embodiment, two gaps 111 are defined in the conductive frame 110. The two gaps 111 include a first gap and a second gap. The first gap and the second gap can divide the conductive frame 110 into three independent conductive branches including a first conductive branch, a second conductive branch and a third conductive branch. Each of the conductive branches is provided with a feeding point and a ground point. The first conductive branch is integrated with a first radiator for radiating the first radio-frequency signals. The second conductive branch can be integrated with a second radiator for radiating the second radio-frequency signals. The third conductive branch can be integrated with a third radiator for radiating the third radio-frequency signals. The third radio-frequency signal can be a WIFI (Wireless-Fidelity) signal, or a Bluetooth™ signal. The working frequency band of the WIFI signal can be in 2.4 GHz and 5 GHz, the working frequency band of the Bluetooth™ signal can be in 2.4 GHz.

Each feeding point can be connected to a filter circuit through a conductive elastic sheet or a screw, and is further connected to the corresponding feeding circuit by the filter circuit. Each feeding circuit can feed current signals to corresponding conductive branch via the filter circuit, the elastic sheet, or the screw, so that the conductive branch (radiator) between the feeding point and the ground point is excited to output a quarter of the current signal or other modes, to generate radiation to radiate different radio-frequency signals.

When the conductive frame 110 is provided with N (N is more than 2) gap s 111, the conductive frame 110 can be divided into N+1 independent conductive branches. N+1 filter circuits and N+1 feeding circuits can correspondingly be arranged. N+1 radiators can be correspondingly integrated on the N+1 independent conductive branches to radiate N+1 radio-frequency signals, and each of the signals have different working radio-frequency bands.

In some embodiments, an electronic device 10 is provided. The electronic device 10 includes a substrate 130 and an antenna assembly according to any one of the embodiments. The substrate 130 is received in the cavity defined by the conductive frame 110. A filter module 210 and a feeding module 220 are arranged on the substrate 130.

When the antenna assembly is applied in the electronic device 10, the first conductive branch 113 and the second conductive branch 115 corporately use the same gap 111 to simultaneously radiate the first radio-frequency signal and the second radio-frequency signal, which improves the space utilization of the conductive frame of the electronic device 10. A thickness of the electronic device is reduced without an extra antenna radiator.

By using a same gap 111 to radiate GPS, MHB, N78 and N79 signals, the first radiator and the second radiator can be integrated on the first frame or the third frame of the electronic device 10, which improves the utilization of the top frame or the bottom frame of the electronic device 10. Meanwhile, instead of integrating an antenna assembly into a side frame of the electronic device 10, a height of the side frame can be reduced to be less than 1 mm. The height of the side frame in a cross-section direction can be the width of the conductive frame 110 in the thickness direction of the electronic device 10. The height of the conductive frame 110 in a cross-section direction is one of the main factors affecting the radiation efficiency. Under the trend of the curved surface screen being larger and larger, a height of the side frame is limited, which causes the antenna clearance is reduced greatly.

Using the design in the embodiments of the disclosure, the antenna assembly can be integrated into a top frame or a bottom frame of the electronic device 10 which maintains enough antenna clearance. And by the design of the switching circuit, a requirement of multi-frequency bands and multi-antennas technology can be satisfied even the top frame or the bottom frame having limited length.

Any reference to memory, storage, database, or other media used in this application can include non-volatile and/or volatile memory. Suitable non-volatile memory can include read only memory (ROM), programmable ROM (PROM), electrical programmable ROM (EEPROM), electrically erased programmable ROM (EEPROM) or flash memory. Volatile memory can include a random-access memory (RAM), which is used as an external cache. As an explanation rather than the limit, RAM can be obtained in a variety of forms, such as static RAM (SRAM), dynamic RAM (DRAM), synchronous DRAM (SDRAM), dual data rate SDRAM (DDR SDRAM), enhanced SDRAM (ESDRAM), synchronous Synchlink DRAM (SLDRAM), Memory Bus (RAMBUS) Direct RAM (RDRAM), Direct Memory Bus Dynamic RAM (DRDRAM), and Memory Bus Dynamic RAM (RDRAM).

Each technical feature of the above embodiments can be combined by any means. To make the description simple, not all available combinations of all technical featured embodiments are described, however, as long as the combinations of these technical characteristics are not contradictory, those should be included in the scope of the specification.

The above embodiments are merely expressed in several embodiments of the present application, which are described more specific and detailed, but it is not understood to be limited to the patent scope of the present application. It should be noted that in terms of one of ordinary skill in the art, several deformations and improvements can be made without departing from the context of this application, which belongs to the scope of the present application. Therefore, the scope of protection of the patent according to the present disclosure should be taken as the appended claims.

What is claimed is:

1. An antenna assembly, comprising: a conductive frame, and an antenna circuit;
wherein the conductive frame comprises a first conductive branch and a second conductive branch, the first conductive branch and the second conductive branch are separated by a first gap, a first radiator is integrated with the first conductive branch, and a second radiator is integrated with the second conductive branch;
wherein the antenna circuit comprises a filter module and a feeding module, the filter module comprises a first filter circuit and a second filter circuit, and the feeding module comprises a first feed circuit and a second feed circuit;
wherein the first feed circuit is configured to feed an adjustable first current signal to the first conductive branch via the first filter circuit and a first feeding point on the first conductive branch, and the second feed circuit is configured to feed a second current signal to the second conductive branch via the second filter circuit and a second feeding point on the second conductive branch;
wherein the first radiator is configured to radiate a first radio-frequency signal based on the first current signal, and the second radiator is configured to radiate a second radio-frequency signal based on the second current signal.

2. The antenna assembly of claim 1, wherein the first filter circuit is a high-pass filter circuit, and the second filter circuit is a low-pass filter circuit.

3. The antenna assembly of claim 2, wherein
the first filter circuit comprises a first capacitor and a first inductor;
a first end of the first capacitor is connected with a first end of the first inductor and the first feeding point; and
a second end of the first capacitor is connected with the first feed circuit, and a second end of the first inductor is grounded.

4. The antenna assembly of claim 2, wherein
the second filter circuit comprises a second capacitor and a second inductor;
a first end of the second inductor is connected with a first end of the second capacitor and the second feeding point; and
a second end of the second inductor is connected with the second feed circuit, and a second end of the second capacitor is grounded.

5. The antenna assembly of claim 1, wherein the antenna circuit further comprises a switching module, wherein the switching module is connected with the first feeding point and the first filter circuit, and the switching module is configured to adjust the first current signal fed to the first feeding point, so that the first radiator radiates the first radio-frequency signal based on the adjusted first current signal.

6. The antenna assembly of claim 5, wherein the switching module comprises a plurality of third capacitors and a switch unit, the switch unit comprises a control end and a plurality of selection ends, the control end is connected with the first feeding point and the first filter circuit, and each of the selection ends is grounded via a third capacitor.

7. The antenna assembly of claim 5, wherein the switching module comprises a plurality of third inductors and a switch unit, the switch unit comprises a control end and a plurality of selection ends, the control end is connected with the first feeding point and the first filter circuit, and each of the selection ends is grounded via a third inductor.

8. The antenna assembly of claim 1, wherein
the first conductive branch is provided with a first ground point, and the first radiator is formed between the first feeding point and the first ground point; and
the second conductive branch is provided with a second ground point, and the second radiator is formed between the second feeding point and the second ground point.

9. The antenna assembly of claim 1, wherein the antenna circuit further comprises a first matching circuit and a second matching circuit;
wherein the first matching circuit is connected between the first filter circuit and the first feed circuit and is configured to adjust the first radio-frequency signal; and
wherein the second matching circuit is connected between the second filter circuit and the second feed circuit and is configured to adjust the second radio-frequency signal.

10. The antenna assembly of claim 9, wherein the first matching circuit comprises a capacitor and/or an inductor, the second matching circuit comprises a capacitor and/or an inductor.

11. The antenna assembly of claim 1, wherein
the first filter circuit is coupled to the first feeding point of the first conductive branch via a first feeding part, and
the second filter circuit is coupled to the second feeding point of the second conductive branch via a second feeding part.

12. The antenna assembly of claim 1, wherein the conductive frame further comprises a third conductive branch, the first conductive branch, the second conductive branch and the third conductive branch are separated from each other by a first gap and a second gap, a third feeding point and a third ground point are arranged on the third conductive branch, and a third radiator is integrated with the third conductive branch and is configured to radiate a third radio-frequency signal.

13. The antenna assembly of claim 1, wherein a working frequency band of the first radio-frequency signal at least comprises two working frequency bands of fifth generation new radio (5G NR) signal and two working frequency bands of long term evolution (LTE) signal, and the second radio-frequency signal comprises a satellite positioning signal.

14. The antenna assembly of claim 13, wherein the working frequency bands of the 5G NR signal comprise a N78 frequency band and a N79 frequency band, and the satellite positioning signal comprises a GPS L1 frequency band signal or a GPS L5 frequency band signal.

15. An electronic device, comprising an antenna assembly, wherein the antenna assembly comprises:
a conductive frame, and an antenna circuit on a substrate;
wherein the conductive frame comprises a first conductive branch and a second conductive branch, the first conductive branch and the second conductive branch are separated by a first gap, a first radiator is integrated with the first conductive branch, and a second radiator is integrated with the second conductive branch;
wherein the antenna circuit comprises a filter module and a feeding module, the filter module comprises a first filter circuit and a second filter circuit, and the feeding module comprises a first feed circuit and a second feed circuit;
wherein the first feed circuit is configured to feed an adjustable first current signal to the first conductive branch via the first filter circuit and a first feeding point on the first conductive branch, and the second feed circuit is configured to feed a second current signal to the second conductive branch via the second filter circuit and a second feeding point on the second conductive branch;
wherein the first radiator is configured to radiate a first radio-frequency signal based on the first current signal, and the second radiator is configured to radiate a second radio-frequency signal based on the second current signal; and
wherein the substrate is in a receiving space defined by the conductive frame.

16. The electronic device of claim 15, wherein the first filter circuit is a high-pass filter circuit, and the second filter circuit is a low-pass filter circuit.

17. The electronic device of claim 16, wherein
the first filter circuit comprises a first capacitor and a first inductor;
a first end of the first capacitor is connected with a first end of the first inductor and the first feeding point;
a second end of the first capacitor is connected with the first feed circuit, and a second end of the first inductor is grounded;
the second filter circuit comprises a second capacitor and a second inductor;
a first end of the second inductor is connected with a first end of the second capacitor and the second feeding point;
a second end of the second inductor is connected with the second feed circuit, and a second end of the second inductor is grounded.

18. The electronic device of claim 15, further comprising a switching module, wherein the switching module is connected with the first feeding point and the first filter circuit, and the switching module is configured to adjust the first current signal fed to the first feeding point, so that the first radiator radiates the first radio-frequency signal based on the adjusted first current signal.

19. The electronic device of claim 15, wherein the conductive frame comprises a first frame and a third frame which are opposite to each other, a second frame and a fourth frame which are opposite to each other, wherein the second frame respectively connected with the first frame and the third frame, wherein the first conductive branch and the second conductive branch are integrated on the first frame or the third frame of the electronic device.

20. An antenna assembly, comprising:
a first conductive branch; and
a second conductive branch;
wherein a gap is defined between the first conductive branch and the second conductive branch, and separates the first conductive branch from the second conductive branch; and
wherein the first conductive branch is configured to be fed a first adjustable signal for radiation of a first radio-frequency signal with different frequency bands, and the second conductive branch is configured to be fed a second current signal for radiation of a second radio-frequency signal with a fixed frequency band.
